(19) United States
(12) Patent Application Publication
(10) Pub. No.: US 2026/0212783 A1
(43) Pub. Date: Jul. 23, 2026

(54) MULTIMODAL MONOMATERIAL PHANTOM, AND USE

(71) Applicant: Christian-Albrechts-Universitaet zu Kiel, Kiel (DE)

(72) Inventors: Haoyi Qiu, Kiel (DE); Leonard Siebert, Altenholz (DE); Joerg Bahr, Altenholz (DE); Rainer Adelung, Kiel (DE)

(21) Appl. No.: 19/145,427

(22) PCT Filed: Dec. 14, 2023
(86) PCT No.: PCT/DE2023/100974

§ 371 Date: Jul. 2, 2025

(30) Foreign Application Priority Data
Dec. 15, 2022 (DE) 10 2022 133 558.5

(51) Int. Cl. G09B 23/28; G09B 23/30

(52) U.S. Cl. CPC G09B 23/286; G09B 23/30

(57) ABSTRACT

A multimodal, monomaterial phantom including surrogates for different tissue types, wherein the phantom is formed from at least two surrogates, the surrogates are arranged separately so as to be in contact with one another in an anatomically appropriate manner, and the surrogates are designed and/or arranged to replicate the same and/or different tissue types. The surrogates can be manufactured from the same material system, wherein the material system includes a hydrogel, a diversity and/or an adaptability of the surrogates formed is produced or formed by way of varying formulations within the material system and by controlling the polymerization of the hydrogel in the cross-linking process, and the CT attenuation and shear wave velocity within the material system are adjustable independently of one another. The, wherein the surrogates formed are distinguishable from one another using non-invasive medical diagnostic and imaging methods

The invention relates to a multimodal, monomaterial phantom comprising surrogates for different tissue types, wherein the phantom is formed from at least two surrogates, the surrogates are arranged separately, anatomically correspondingly in contact with each other, and the surrogates are formed and/or arranged to simulate the same and/or different tissue types.

The invention also relates to the use of a multimodal, monomaterial phantom.

In particular, the object according to the invention and its use is a medical, multimodal, monomaterial phantom comprising surrogates for different tissue types. Medical in the sense of the disclosure is to be understood in such a way that it is a phantom that is capable of reproducing medical conditions.

Multimodal in the sense of the present invention is understood to mean usable in multiple ways. In particular, the phantom may be categorized as being capable of being examined in multiple ways, in particular meaningfully. In addition, multimodality can refer to the various measurement methods that can be applied to it, for example, among other things, surgical training. For the purposes of the present invention, monomaterial is understood as being manufactured from the same material system.

Today, phantoms already exist for almost all aspects in the examination chain leading to surgery, including computed tomography (CT), ultrasound (US) imaging and mechanically surgical techniques.

The current phantoms are not multimodal, i.e. they are only tailored to one of these techniques. They are not suitable for combining several techniques, as they are only tailored to one important aspect.

As a rule, phantoms replicate soft tissue by manufacturing them from elastomeric materials. Silicones are most commonly used for ultrasound phantoms, but they comprise a higher attenuation for X-rays in CT than normal tissue. Silicones can be adjusted in their elasticity by changing their cross-linking. However, their CT attenuation depends on their density and atomic mass and cannot reach the level of normal soft tissue in the object. Therefore, they cannot be used for both measurements independently. Secondly, these phantoms are not suitable for later surgical training as they are difficult to cut to size and have to be expensively manufactured elsewhere. Since the phantom was destroyed after the initial surgical training, the reusability of the silicone phantom for the originally intended purpose is limited. From both an economic and environmental point of view, these already destroyed models must be reused, which has a significant negative impact on surgical training. In this respect, such phantoms may even already comprise certain abnormalities, i.e. in principle diseases.

In particular, many difficult operations such as tumor resection on vital organs require precise and multimodal imaging to localize the affected tissue. The exact location of the tumor and the detection of risks, such as proximity to an artery, are crucial for a positive surgical outcome. However, despite precise imaging, the surgeon's work is severely hampered by the lack of correspondence between the images and the real perspective. A tumor still looks like the surrounding tissue and is difficult to distinguish by simple visual inspection. This is especially true for laparoscopic, robot-assisted surgery, where there is no haptic feedback. The problem is that surgeons usually only have one chance, which in itself is time-critical. Adequate preparation for surgery through training and trial tests prior to the respective procedure can facilitate the process and drastically increase the chances of a positive surgical outcome. This requires phantoms to simulate the pathological details.

The state of the art knows numerous examples of so-called “tissue-mimicking materials” (TMM) that are used in medical phantoms.

For example, the publication U.S. Pat. No. 6,635,486 B2 presents a phantom material consisting of an open-cell network of polyurethane, wherein the cells are filled with vegetable oil and embedded in a gel matrix. Copper salts and glass beads can optionally be added. The material is formed into simple geometric shapes in a box and serves as a test body for multimodal medical imaging. Among other things, ultrasound properties and magnetic resonance measurement data are modeled on living tissue. X-ray opacity and scattering can also be adjusted. The phantom described is not intended for targeted destruction, but as a long-term stable test body. Accordingly, its manufacturing may also be somewhat more expensive.

U.S. Pat. No. 10,726,742 B2 discloses a 3D printable metamaterial that is designed to establish an anisotropy of the physical parameters, in particular the modulus of elasticity. For this purpose, a second, structured material is embedded in a first material, which is brought into the shape of an organ. Each structure of the second material has a predetermined shape, so that the phantom can offer more resistance to deformation along a specified direction, for example, than perpendicular to it. The printed materials here are printable elastic polymers.

U.S. Pat. No. 10,755,600 B2 discloses a layered phantom material comprising two or more layers, which is essentially manufactured from silicone rubber and oil. The purpose here is to model a patient surface into which a medical procedure is to be performed, for example a subcutaneous injection.

The publication US 2021/0373108 A1 discloses a phantom material that is suitable for calibrating ultrasound and magnetic resonance imaging. Possible ingredients include sodium alginate as a gelling agent and coconut oil as a vegetable fat. Significant amounts of protein powder are also added in order to adjust the dielectric properties for MRI suitability.

From the work of Aoyagi, Minoru and Hiraguri, Tomomi, “Ultrasound Phantom Using Sodium Alginate as a Gelling Agent”, J Ultrasound Med 36, 11, pp. 2345-2353, https://doi.org/10.1002/jum.14252, a phantom material made of sodium alginate is known whose degree of polymerization or cross-linking can be varied to match sound velocity and ultrasound attenuation to tissue conditions. It is emphasized that the mechanically properties of the alginate correspond well to those of human tissue, so that soft tissue surrogates can be manufactured without expensive chemicals or special equipment. However, it is difficult to simulate actual anatomical structures with the proposed phantom. With the phantom, the ultrasound properties of human tissue can be reproduced well.

US 2019/0 130 791 A1 discloses a method for evaluating the performance of a human or a robot performing a medical procedure using a phantom resembling a human or animal organ or tissue, and an evaluation tool comprising such a phantom.

BOOTSMA, K., et al: Materials Used as Tissue Phantoms in Medical Simulation. In: Springer Int. Publ., 2016 (Studies in mechanobiology, tissue engineering and biomaterials). pp. 1-48 discloses simulation technology that can be used to train the performance of various clinical procedures without putting patients at risk, wherein there is a need for more realistic tissue analog materials that take into account the biomechanical responses of tissues in different situations, wherein an overview of materials used in medical simulation is given here.

HERNÁNDEZ-GONZÁLEZ, A. C., Tellez-Jurado, L., Rodriguez-Lorenzo, L. M.: Alginate hydrogels for bone tissue engineering, from injectables to bioprinting: A review. Carbohydrate polymers, 2020, vol. 229, pp. 1-22. doi: 10.1016/j.carbpol.2019.115514 discloses injectable alginate hydrogels and alginate composites for applications in bone tissue regeneration and the properties of alginates that have made them useful for medical applications.

DABBAGH, A., et al: Tissue-mimicking gel phantoms for thermal therapy studies. In: Ultrasonic imaging, 2014, vol. 36, no. 4, pp. 291-316. doi: 10.1177/01617346145263 reveals that tissue-mimicking phantoms currently available for routine biomedical applications may not be suitable for high-temperature experiments or calibration of thermal modalities, necessitating the development and manufacturing of customized thermal phantoms with tailored properties for thermal therapy studies, wherein various materials and techniques that may be relevant for manufacturing gel-state phantoms are considered here.

MIRDAMADI, E., et al: FRESH 3D bioprinting a full-size model of the human heart. In: ACS Biomaterials Science & Engineering, 2020, Vol. 6, No. 11, pp. 6453-6459. doi: 10.1021/acsbiomaterials.0c01133In: ACS Biomaterials Science & Engineering, 2020, vol. 6, no. 11, pp. 6453-6459. doi: 10.1021/acsbiomaterials.0c01133 reveals that there are advances in embedded three-dimensional (3D) bioprinting that increase the design space for manufacturing geometrically complex tissues with hydrogels that have mechanically similar properties to native tissues and tissues and organs in the human object. With FRESH-printed alginate, high print fidelity can be achieved on a low-cost printer platform, wherein mechanically tunable and suturable models can also be produced.

AOYAGI, M.: Sodium alginate ultrasound phantom for medical education. In: Ultrasonic Imaging, 2021, vol. 43, no. 5, pp. 253-261. doi: 10.1177/01617346211018643 discloses that ultrasound phantoms used for medical student education should not only mimic the ultrasound properties of human soft tissues, but should also be inexpensive and easy to manufacture, wherein an ultrasound phantom made of calcium alginate hydrogel is proposed, with speckle patterns occurring being reduced by adding ethanol.

DE 10 2016 217 316 B3 provides a training model which represents at least an external anatomical shape of the human or animal object. The training model is used for practicing minimally invasive percutaneous image-guided intervention techniques, wherein the material and shape of the training model and its components are selected to be suitable for examination by ultrasound, MRI and CT as well as for puncture and palpation.

Already commercially available phantoms are, for example, the phantom from PetVitalShop, which was specially developed for computer tomography and cannot be cut and used for surgical training. It is very expensive. The CT phantoms from other companies have the same disadvantages and limitations.

The common training phantoms (e.g. from Erler-Zimmer) are usually phantoms for basic training and these phantoms cannot be used for CT measurements.

In the surgical training phantom from HumanX, the various organs or tissues can be incised. However, they are differentiated or identified by color and the structure is open to the surgeon, which is not the case in reality. The various organs cannot be identified by CT or other measurements.

The problems in the state of the art are essentially that the current phantoms are not multimodal, meaning that they are designed for only one technique, i.e. computed tomography (CT), ultrasound imaging (US) or mechanically surgical technique. They are not suitable for combining several techniques, as they are only tailored to one important aspect. As a rule, phantoms replicate soft tissue by manufacturing them from elastomeric materials. Silicones are most commonly used for ultrasound phantoms, but they comprise a higher attenuation for X-rays in CT than normal tissue. The elasticity of silicones can be adjusted by changing their cross-linking. However, their CT attenuation depends on their density and atomic mass and cannot reach the level of normal soft tissue in the object. Therefore, they cannot be used for both measurements independently. Secondly, these phantoms are not suitable for later surgical training as they are difficult to cut and expensive to manufacture elsewhere. Since the phantom is destroyed during the initial surgical training, the reusability of the silicone phantom for the originally intended purpose is limited. However, from both an economic and environmental point of view, these already destroyed models must be reused, which has a significant negative impact on surgical training.

The present invention is based on the task of providing a phantom, in particular for the medical field, which can be used multimodally and at the same time is as simple and inexpensive as possible to manufacture.

This task is solved with a multimodal, monomaterial phantom according to the main claim.

A multimodal monomaterial phantom comprises surrogates for different tissue types, wherein
the phantom is formed from at least two surrogates;
the surrogates are arranged separately, in anatomically corresponding contact with each other;
the surrogates are formed and/or arranged to simulate the same and/or different tissue types;
wherein
the phantom and/or the surrogates consist of exactly one material system at or during manufacturing, wherein the material system comprises a material composition of at least:
   sodium alginate
and
   glucono-delta-lactone (GDL) or an acid-forming compound by hydrolysis or lactones
and
   calcium carbonate
and
   fat
and
   water
in the form of a hydrogel
and
the material system is formed in at least two different variations of the material system composition within the phantom and/or surrogate.

A phantom can be created here that is very inexpensive and easy to produce.

In particular, a mono-material system is provided here, which nevertheless ensures adjustability, so that the requirements for a phantom are fully met here.

There are also no cavities between the individual areas of the phantom due to poor bonding with different materials.

The glucono-delta-lactone (GDL) or the acid-forming compound by hydrolysis or the lactones are intended to delay the reaction of the calcium carbonate, which itself is insoluble in water and is decomposed by the acid formed by hydrolysis. The formation of the acid depends on the type of acid-forming compound. Lactones carry out an acid hydrolysis and thus a ring opening in which the carboxylic acid is formed back. This can then attack the calcium carbonate, dissolve it and thus provide the calcium ions required for cross-linking.

The substances in the material composition are decisive in the manufacturing of the phantoms, as these substances are naturally transformed during the reaction. The phantoms are designed in such a way that the calcium carbonate ultimately reacts with GDL/lactones so that they are essentially no longer present in this form.

Instead of calcium carbonate, we could therefore also speak of calcium ions.

The invention can also work with a different calcium source and acidity regulator, wherein the acidity regulator need only decompose over time and provide a strong enough acidity to dissolve the calcium source.

Calcium carbonate, for example, is particularly suitable because the CO₂escapes from the phantom so that no unnecessary residues of the compound are left behind. The GDL forms gluconic acid via hydrolysis in water, which then reacts with the calcium carbonate and forms water-soluble calcium gluconate, so that these two substances mentioned here will no longer be present in the final phantom. The calcium ions react with the sodium alginate and displace the sodium ions, which then form sodium gluconate, which is also water-soluble.

A further preferred embodiment is given by varying formulations and/or percentages within the material composition of the material system and by controlling the polymerization of the hydrogel in the crosslinking process, wherein
a diversity and/or adaptability of the formed surrogates is effected or is formed;
within the material system, the CT attenuation and the shear wave velocity can be adjusted independently of one another;
   wherein the formed surrogates are
      can be distinguished from one another with non-invasive medical diagnostic and imaging techniques comprising ultrasound imaging and X-ray CT
      mimic the mechanically properties of real tissue as closely as possible;
      are cuttable;
      are moldable and dimensionally stable.

The material system can also comprise colorants and/or anti-mold agents.

In particular, and most preferably, the material system composition has variations in the range of (weight %)
0.1 to 20 percent sodium alginate
0.01 to 20 percent calcium carbonate
0.01 to 20 percent glucono-delta-lactone (GDL)
0.1 to 50 percent fat
0 to 10 percent surfactant
0 to 5 percent anti-mould agent
0 to 5 percent colorant
and
   water
in total 100%.

The medical phantoms presented here can mimic various aspects of medical procedures such as computed tomography (CT) and ultrasound (US) as well as surgical procedures. In contrast to the phantoms currently known in the prior art, the phantoms presented here are not limited to a specific imaging modality or procedure, making them versatile, as the CT, US and mechanically properties of the existing material system can be adjusted independently.

In contrast to the phantoms known in the prior art, which are generally made from synthetic polymers that are costly and difficult to produce in terms of both material and manufacturing and are also harmful to the environment, disclosed herein is a simple and high performance material system with independently adjustable CT, US and mechanically properties.

The system disclosed herein is particularly beneficial to surgical practice as the materials are inexpensive and the phantoms are easy to manufacture, making realistic and versatile phantoms available to everyone to improve patient care.

In particular, an environmentally friendly hydrogel composite of sodium alginate and vegetable fat has been developed for the manufacturing of multipurpose medical phantoms. The independent adjustment of CT, US and mechanical properties works reliably here and the properties can be precisely determined by the respective formulation and variation of the individual components of the material system and their composition.

Another possible embodiment is: a multimodal, monomaterial phantom comprises surrogates for different tissue types, wherein
the phantom is formed from at least two surrogates;
the surrogates are arranged separately, anatomically in contact with each other;
the surrogates are formed and/or arranged to simulate the same and/or different tissue types; wherein
the surrogates can be produced from the same material system, wherein the material system comprises a hydrogel;
by varying formulations within the material system and by controlling the polymerization of the hydrogel in the crosslinking process
   a diversity and/or adaptability of the formed surrogates is effected or formed;
   within the material system, the CT attenuation and the shear wave velocity can be adjusted independently of one another;
   wherein the formed surrogates
      can be distinguished from one another with non-invasive medical diagnostic and imaging techniques including ultrasound imaging and X-ray CT
      mimic the mechanically properties of real tissue as closely as possible; and
      are cuttable;
      are moldable and dimensionally stable.

It should be noted at this point that the diversity and/or adaptability is to be understood in the sense of the properties according to the invention, wherein, for example, equipping the material with higher cell compatibility properties would not be seen here in the sense of the invention.

In particular, the material system may comprise sodium alginate.

The material system can also comprise fat and/or vegetable fat.

The material system may comprise the components sodium alginate, fat, calcium carbonate, water and glucono-delta-lactone (GDL).

Preferably, the material system may comprise 0.1 to 20 percent sodium alginate and 0.1 to 50 percent fat.

Furthermore, the material system may comprise colorants and/or anti-mold agents.

In a preferred embodiment, the material system may comprise 0.1 to 20 percent sodium alginate, 0.01 to 20 percent calcium carbonate, 0.01 to 20 percent glucono-delta-lactone (GDL), 0.1 to 50 percent fat, 0 to 10 percent surfactant, 0 to 5 percent anti-mold agent, 0 to 5 percent colorant and water.

In addition, the material system is preferably easy to dispose of or can be disposed of as normal organic waste. The material system can also be vegan and/or food-safe.

The multimodal, monomaterial phantom can be used in particular in the surgical and/or radiological training and/or further training of specialist personnel, in the preparation of surgical interventions and in the development and/or calibration of devices for robot-assisted surgery.

In a preferred embodiment, the multimodal, monomaterial phantom can be used to model individual organs and/or tissues, organ arrangements and/or tissue arrangements, to model organ arrangements and/or tissue arrangements together with defined pathologies and/or to model phantom bodies comprising organ arrangements and tissue arrangements.

The phantom according to the invention can be used for surgical procedures, which means that the phantom is damaged and destroyed in the course of its use. The phantom is composed of separately and anatomically sensibly arranged surrogates for soft tissue. These surrogates can be cut and reproduce the mechanical properties and radiopacity of real tissue as closely as possible.

They are also relatively quick and inexpensive to produce and should be able to be disposed of like normal organic waste (e.g. slaughterhouse waste) after their final use.

Surrogates based on sodium alginate can be diversified into a wide range for very different soft tissues by adding fats and controlling the polymerization in the cross-linking process. Wherein not only individual organs, but also more complex organ arrangements including certain pathologies—especially tumors—can be modeled from the same material system. This not only simplifies the manufacturing process of a phantom overall, but also comes closer to the conditions of real anatomy and later allows the remains to be disposed of largely without dissection.

Thus, the phantom according to the invention makes it possible to provide phantom bodies in which only the bones are still formed from 3D-printed plastic and these can also be replaced by the phantom material, depending on the phantom material.

Of great importance for the use of multimodal, monomaterial phantoms is that they generate realistic measurements during treatment with non-invasive medical diagnostic and imaging procedures, particularly in ultrasound diagnostics and X-ray CT imaging. In the future, these techniques will also be used in robot-assisted surgery, and new devices for this purpose must first be tested and calibrated on phantoms—at least during development. Special phantoms, such as the phantom according to the invention, with pathologies recognizable by design for the robot, for example cancerous ulcers or tissue pockets with hemorrhages, are advantageous here.

The classic measured values of X-ray attenuation (measured in Hounsfield units, HU) and shear wave velocity (SWV, in m/s) are particularly important for this reason, wherein the latter is a measure of the elasticity of the tissue. The values for this can be varied independently of each other in physiologically sensible intervals by the material formulation.

Weak contrasts (HU±2, SWV±0.2 m/s) can also be set up at the interface in surrogates in contact with each other, which make the course of the interface just detectable with imaging. Stronger contrasts can be generated without any problems.

The multimodal, monomaterial phantom provides a material system that allows the mechanical properties and CT damping to be adjusted independently of each other.

A material system can preferably consist of 0.1-20% sodium alginate, 0.01-20% CaCO3, 0.01-20% glucono-delta-lactone (GDL), 0.1-50% (e.g. vegetable/coconut) fat, 0-10% surfactant, 0-5% anti-mold agent, 0-5% dye and water. The stiffness is adjusted, for example, by different cross-linking in the material system, which does not lead to a change in the CT contrast. The addition of grease can reduce the CT contrast and does not lead to an irreversible change in stiffness.

Through a suitable combination of the cross-linking density of the hydrogel (e.g. sodium alginate) and the concentration ratio between the hydrogel and a fat component, the CT contrast and the mechanically properties can be tailored to the desired values.

In addition to CT contrast and mechanically, shear wave elastography has become a rapidly developing ultrasound imaging technique before and during surgery to identify lesions. Therefore, the shear wave velocity is also considered within the developed composite system. This velocity is directly linked to the shear elastic modulus and the density of the tissue.

The material system is malleable and true to shape so that, for example, organ-like shapes and/or body parts can be formed from it. Several versions of the material system with different compositions are formed into a phantom body (i.e. a dummy), which can then be used for CT and surgical exercises. The phantom body reproduces physiological and pathological features that are useful for teaching surgery and CT measurements.

The multimodal, monomaterial phantom can be used to provide the most realistic training conditions possible. For example, a CT image can be measured. A tumor located in the phantom can be identified due to the different CT attenuation. The CT image can then be used to train the surgeon to find the position of the tumor and remove it correctly.

The components of the developed material system are, for example, food-safe, degradable and environmentally friendly when using a combination of sodium alginate and fat as base materials. Even more importantly, the components are cheap and easy to procure, even for developing countries. The material system is simple and easy to manufacture as required.

For these aforementioned reasons, the provision of the multimodal, monomaterial phantom can ultimately lead to better patient care.

The invention is described below with reference to the accompanying figures in the figure description, wherein these are intended to explain the invention and are not necessarily limiting:

It shows:

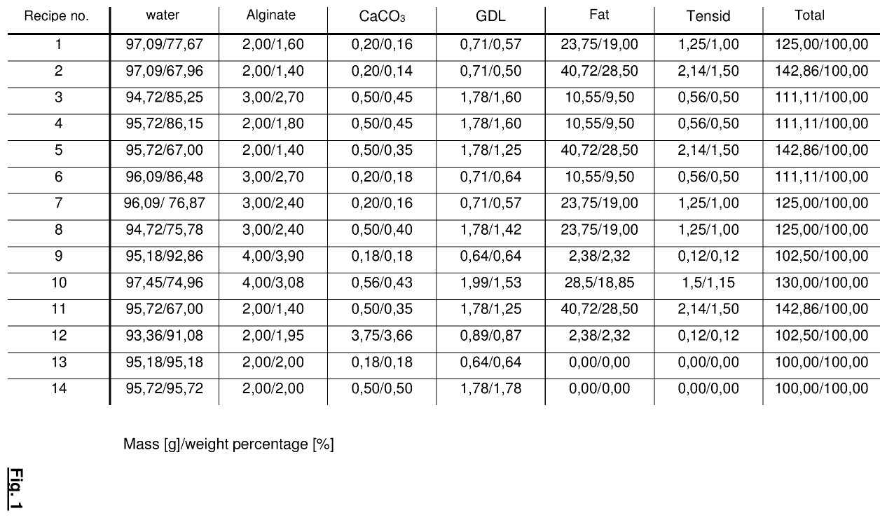

FIG. 1 a tabular representation of exemplary recipe compositions for manufacturing a phantom according to the invention comprising alginate and fat;

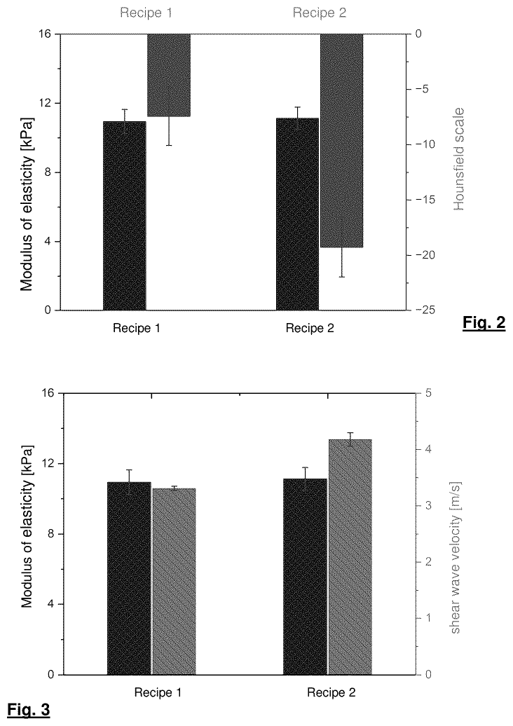

FIG. 2A graphical representation of the test results concerning modulus of elasticity and Hounsfield scale for phantom material manufactured according to two exemplary formulations 1 and 2 with a composition as shown in FIG. 1;

FIG. 3A graphical representation of the test results concerning modulus of elasticity and shear wave velocity for phantom material manufactured according to the exemplary formulations 1 and 2 with a composition as shown in FIG. 1;

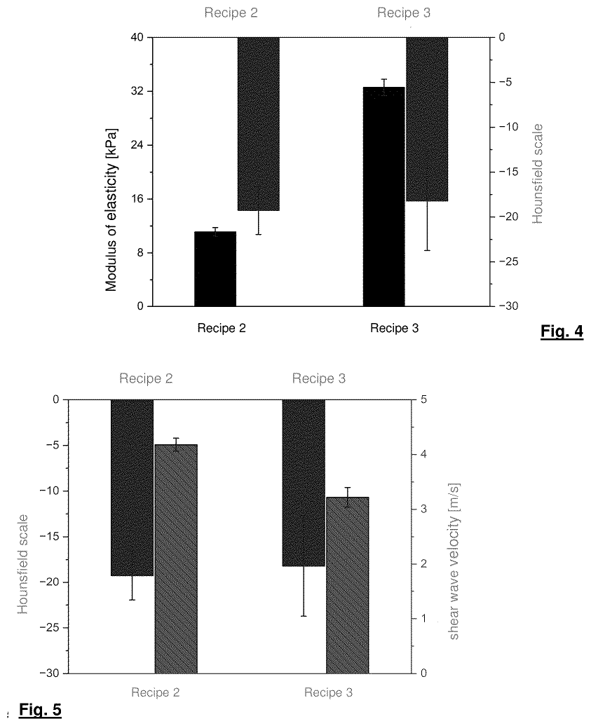

FIG. 4A graphical representation of the test results concerning modulus of elasticity and Hounsfield scale for phantom material manufactured according to two exemplary formulations 2 and 3 with a composition as shown in FIG. 1;

FIG. 5A graphical representation of the test results concerning Hounsfield scale and shear wave velocity for phantom material manufactured according to the exemplary formulations 2 and 3 with a composition as shown in FIG. 1;

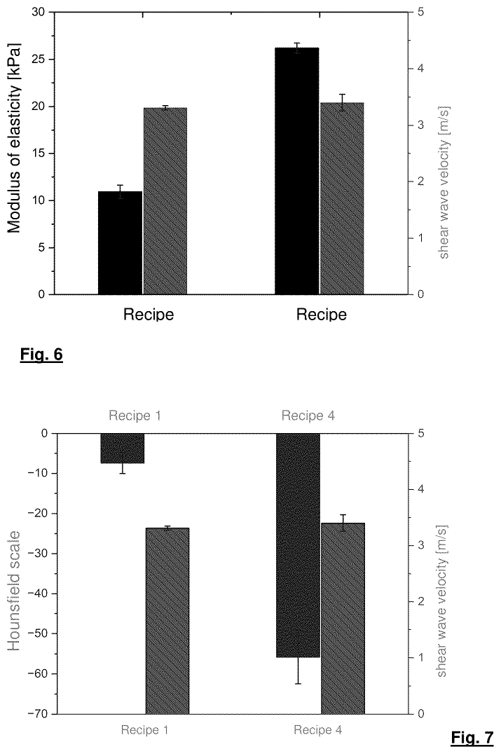

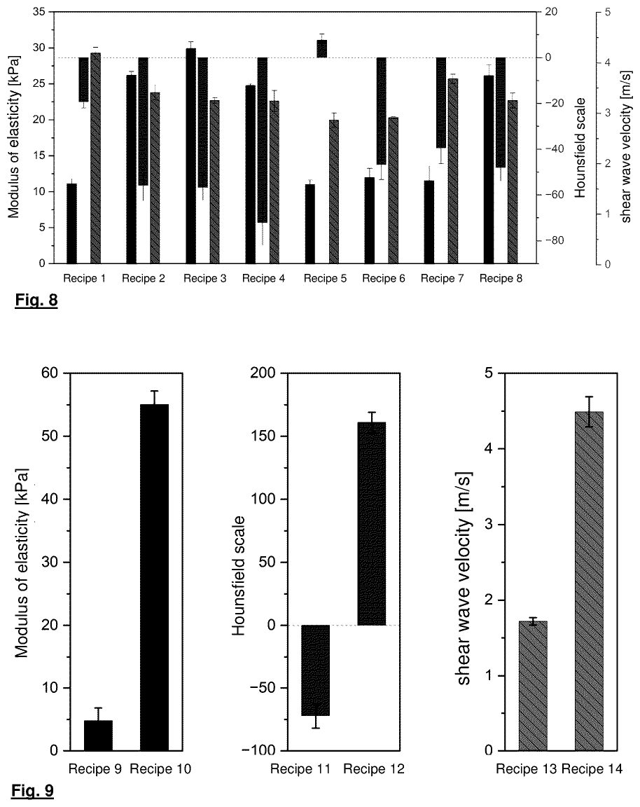

FIG. 6A graphical representation of the test results concerning modulus of elasticity and shear wave velocity for phantom material manufactured according to two exemplary formulations 1 and 4 with a composition as shown in FIG. 1;

FIG. 7A graphical representation of the test results concerning modulus of elasticity and shear wave velocity for phantom material manufactured according to two exemplary formulations 1 and 4 with a composition as shown in FIG. 1;

FIG. 8A graphical representation of the test results concerning modulus of elasticity, Hounsfield scale and shear wave velocity for phantom material manufactured according to the exemplary formulations 1 to 8 with a composition as shown in FIG. 1;

FIG. 9 a graphical representation of the test results concerning modulus of elasticity and/or Hounsfield scale and/or shear wave velocity for phantom material manufactured according to the exemplary formulations 9 to 14 with a composition according to FIG. 1;

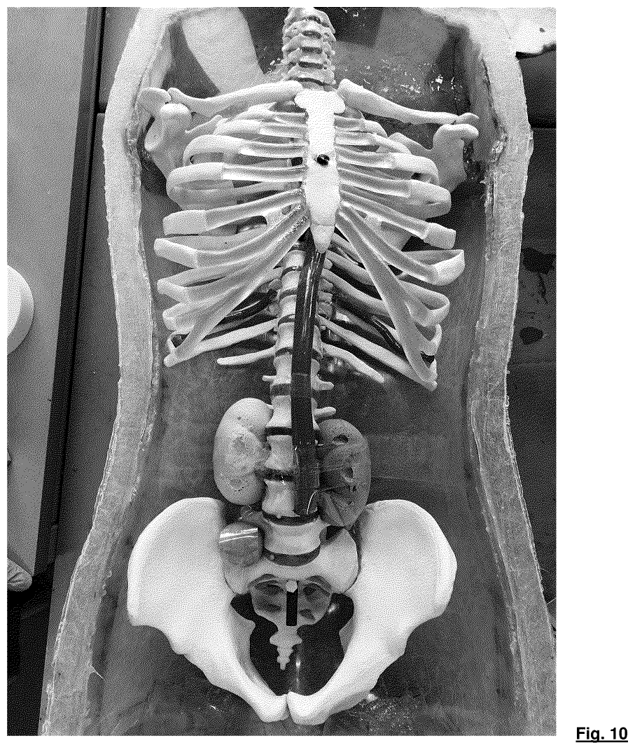

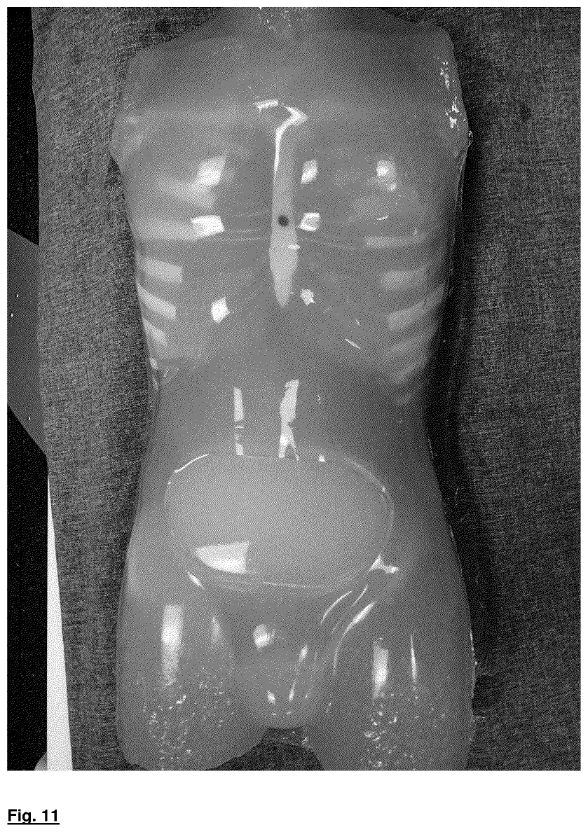

FIG. 10 An exemplary illustration of an embodiment of a phantom body prepared for final molding;

FIG. 11 An example of an embodiment of a finally formed phantom body with a positive kidney tumor;

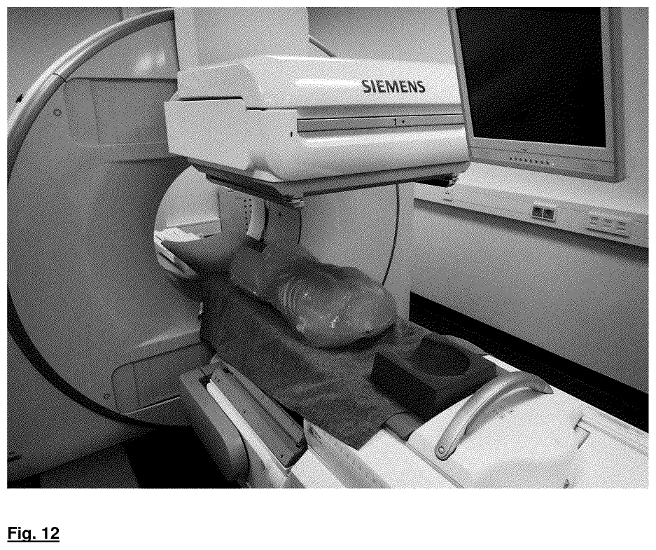

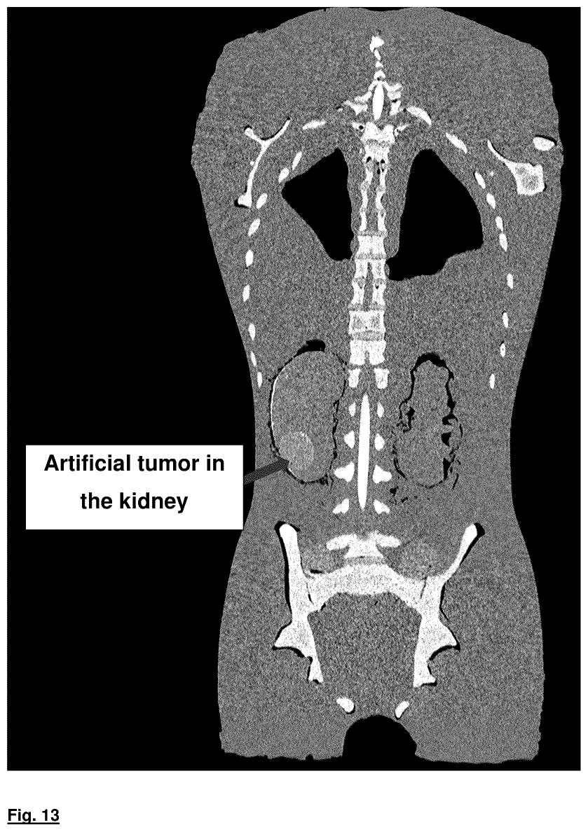

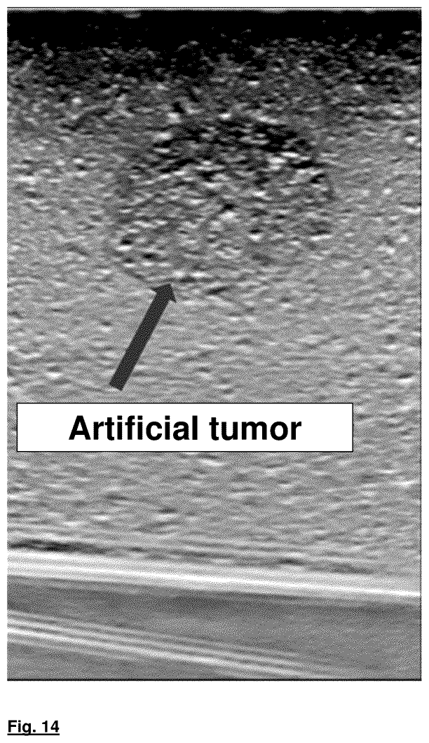

FIG. 12 An exemplary representation of the embodiment of the final shaped phantom body with a positive kidney tumor as shown in FIG. 11 during the performance of CT measurements;

FIG. 13 an exemplary CT image of the embodiment example of the finally formed phantom body with a positive kidney tumor as shown in FIG. 11;

FIG. 14 An exemplary ultrasound image of the embodiment of the final formed phantom body with a positive kidney tumor as shown in FIG. 11;

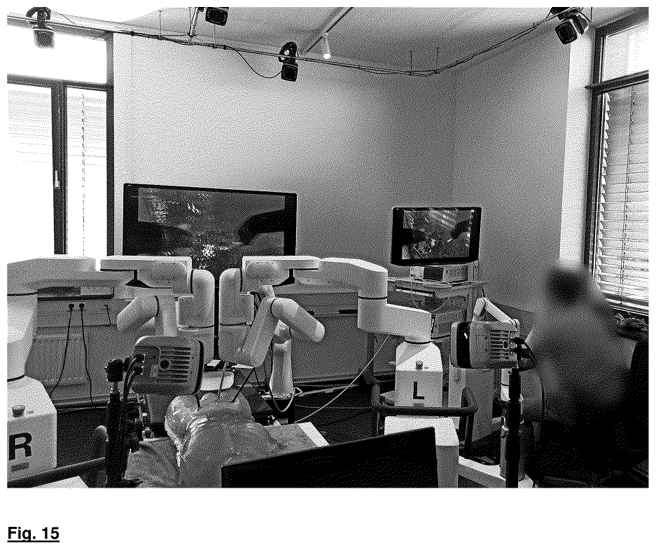

FIG. 15 An exemplary illustration of the embodiment of the finally formed phantom body with a positive kidney tumor as shown in FIG. 11 when used in robot-assisted surgery;

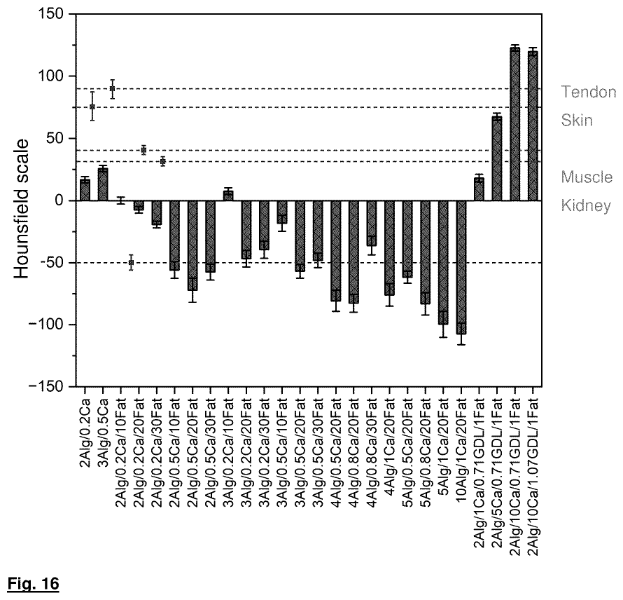

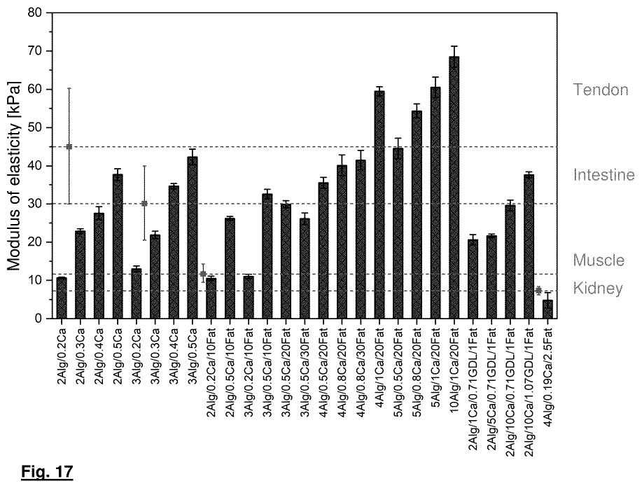

FIG. 16 a graphical representation of test results concerning the Hounsfield scale for an exemplary phantom material manufactured with varying compositions of alginate, fat and calcium carbonate and

FIG. 17A graphical representation of test results concerning the modulus of elasticity for an exemplary phantom material manufactured with varying compositions of alginate, fat and calcium carbonate.

FIG. 1 shows 14 possible exemplary recipe compositions for manufacturing an embodiment of a phantom according to the invention comprising water, alginate, calcium carbonate, GDL, surfactant and fat. In the table, the mass in grams and the percentage by weight are indicated in the individual cells. In the formulation compositions, the mass and percentage by weight of individual ingredients are varied in the different formulations.

FIG. 2 compares the modulus of elasticity and the Hounsfield scale of formulation variants 1 and 2 as shown in FIG. 1. The main difference between the two formulation variants is that more fat is used in formulation variant 2. While there are no significant differences in the modulus of elasticity, the result of the Hounsfield scale is clearly different.

FIG. 3 shows a comparison of the modulus of elasticity and shear wave velocity of formulation variants 1 and 2 as shown in FIG. 1. While there are no significant differences in the modulus of elasticity, the result for the shear wave velocity is clearly different.

Furthermore, FIG. 4 compares the modulus of elasticity and the Hounsfield scale of formulation variants 2 and 3 as shown in FIG. 1. The main difference between the two formulation variants is that more alginate, calcium carbonate and GDL and less fat and surfactants are used in formulation variant 3 compared to variant 2. While there are no significant differences in the Hounsfield scale, the result of the modulus of elasticity is clearly different.

FIG. 5 compares the Hounsfield scale and shear wave velocity of formulation variants 2 and 3 as shown in FIG. 1. While there are no significant differences in the Hounsfield scale, the result of the shear wave velocity is clearly different.

FIG. 6 shows a comparison of the modulus of elasticity and shear wave velocity of formulation variants 1 and 4 as shown in FIG. 1. The main difference between the two formulation variants is that more calcium carbonate and GDL and less fat and surfactant are used in formulation variant 4 compared to variant 1. While there are no significant differences in the shear wave velocity, the result of the modulus of elasticity is clearly different.

In addition, FIG. 7 compares the Hounsfield scale and the shear wave velocity of formulation variants 1 and 4 as shown in FIG. 1. While there are no significant differences in the shear wave velocity, the result of the Hounsfield scale is clearly different.

If the results of the measurements of the modulus of elasticity, Hounsfield scale and shear wave velocity of formulation variants 1 to 4 are compared with each other, the following results are obtained:

| Modulus of | Hounsfield scale | Shear wave velocity | Recipe variations |
|---|---|---|---|
| — | x | | 1 & 2 |
| x | — | | 2 & 3 |
| — | | X | 1 & 2 |
| x | | — | 1 & 4 |
| | — | X | 2 & 3 |
| | x | — | 1 & 4 |

— No significant difference
x Significant difference

For the recipe variations 1 and 2, there are significantly different results for the Hounsfield scale or the shear wave velocity at a constant modulus of elasticity.

For recipe variations 2 and 3, there are significantly different results for the modulus of elasticity or the shear wave velocity with a constant Hounsfield scale.

For recipe variations 1 and 4, there are significantly different results for the modulus of elasticity or the Hounsfield scale at constant shear wave velocity.

It is thus possible to adjust the subsequent mechanically properties of the phantom according to the invention by varying the formulations of the material system. In this embodiment, a material system based on alginate and fat is used as an example.

FIG. 8 shows the results for modulus of elasticity, Hounsfield scale and shear wave velocity for recipe variations 1 to 8. It can be seen from the figure that the properties mentioned can be adjusted independently of each other by varying the recipe of the material system.

The results from FIG. 8 are abstracted again below:

| Modulus of | Hounsfield scale | Shear wave velocity | Recipe variations |
|---|---|---|---|
| x | x | X | 1 & 5, 2 & 4, 2 & |
| | | | 5, 3 & 6, 2 & 8, 4 |
| — | x | X | 1 & 2, 1 & 6, 1 & |
| | | | 7, 2 & 6, 2 & 7 |
| x | — | X | 2 & 3, 5 & 8 |
| x | x | — | 1 & 3, 1 & 4, 1 & |
| | | | 8, 3 & 4, 5 & 6 |
| — | — | X | 4 & 5 |
| — | x | — | 6 & 7 |
| x | — | — | 4 & 8 |

— No significant difference
x Significant difference

For the recipe variations 1 and 5, 2 and 4, 2 and 5, 3 and 6, 2 and 8, 4 and 6, there are significantly different results for the modulus of elasticity, the Hounsfield scale and the shear wave velocity.

For the recipe variations 1 and 2, 1 and 6, 1 and 7, 2 and 6 as well as 2 and 7, there are significantly different results for the Hounsfield scale and the shear wave velocity. The modulus of elasticity comprises no significant differences.

For the recipe variations 2 and 3 as well as 5 and 8, there are significantly different results for the modulus of elasticity and the shear wave velocity. The Hounsfield scale comprises no significant differences.

For the recipe variations 1 and 3, 1 and 4, 1 and 8, 3 and 4 as well as 5 and 6, there are significantly different results for the modulus of elasticity and the Hounsfield scale. The shear wave velocity comprises no significant differences.

There are significantly different results for the shear wave velocity for recipe variations 4 and 5. The modulus of elasticity and the Hounsfield scale comprise no significant differences.

For recipe variations 6 and 7, there are significantly different results for the Hounsfield scale. The modulus of elasticity and the shear wave velocity comprise no significant differences. There are significantly different results for the modulus of elasticity for recipe variations 4 and 8. The Hounsfield scale and the shear wave velocity comprise no significant differences.

FIG. 9 shows in bar charts the modulus of elasticity of recipe variations 9 and 10 according to FIG. 1, the Hounsfield scale of recipe variations 11 and 12 according to FIG. 1 and the shear wave velocity of recipe variations 13 and 14 according to FIG. 1.

The figure shows how significant differences in the values for the individual properties can be achieved by varying the recipe without changing the material system.

The main difference between formulation variants 9 and 10 is that significantly more fat is used in formulation variant 10 than in variant 9. The amounts of calcium carbonate, GDL and surfactant are also increased.

The main difference between formulation variants 11 and 12, on the other hand, is that more calcium carbonate is used in formulation variant 12 and the percentages of GDL, surfactant and, in particular, fat are reduced.

Neither fat nor surfactants are used in formulation variants 13 and 14. The main difference is that the percentage of calcium carbonate and GDL is higher in variant 14 than in variant 13.

With the multimodal, monomaterial phantom according to the invention, it is thus possible to manufacture surrogates for different tissue types by adjusting the physical and mechanically properties of the phantom, wherein each individual organ, tissue and anatomical landmark can be manufactured with the same material system.

FIG. 10 shows a phantom body prepared for final molding from a material system based on alginate, calcium carbonate and fat. The skeleton shown is a commercially available skeleton made of PVC plastic. Replacing the skeleton with a skeleton based on the material system used is also possible by using a high percentage of calcium carbonate in the material system. The vessel-like constructs, the kidney-like constructs and the round ball are individually tailored CT-adapted and mechanically matched surrogates.

FIG. 11 shows a fully formed phantom body. The phantom body comprises a positive kidney tumor and is prepared for a CT measurement.

FIG. 12 shows the phantom body from FIG. 11 during a CT measurement.

In addition, FIG. 13 shows the CT image of the prepared phantom body from FIGS. 11 and 12, where the phantom tumor is designed to comprise a higher CT contrast, as would be the case with a real tumor.

Furthermore, an ultrasound image of a part of the phantom body from FIGS. 11 and 12 is presented in FIG. 14.

FIG. 15 shows a phantom body with a positive kidney tumor during a robot-assisted operation.

FIG. 16 shows a bar chart in which the Hounsfield scale for different formulation variants of a material system based on alginate and fat. Unless explicitly stated, the weight ratio of calcium or, in particular, calcium carbonate and GDL is always 1 to 3.56. In addition, values on the Hounsfield scale are given for real tissue (tendon, skin, muscle, kidney and fatty tissue). These values are taken from the literature.

FIG. 17 shows a bar chart in which the modulus of elasticity is plotted for different formulation variants of a material system based on alginate and fat. Unless explicitly stated, the weight ratio of calcium or, in particular, calcium carbonate and GDL is always 1 to 3.56. In addition, values are given for the modulus of elasticity for real tissue (tendon, intestine, muscle, kidney). These values are taken from the literature.

In order to manufacture a phantom with organs and, for example, a tumor in different CT attenuations and with the correct mechanically properties, a desired material variation can be selected in particular from the exemplary variations listed in FIG. 16 and FIG. 17.

As the components of the exemplary material system used in the illustrations are cheap, food-safe, degradable and easy to procure even for developing countries, they comprise a number of advantages that make their use appear attractive. The exemplary material system is simple and easy to manufacture as required and can be easily disposed of after the surgical training.

Further design example:

The following is a description of an exemplary manufacturing process for a phantom according to the invention using a specific manufacturing example in the form of recipe 1 according to FIG. 1 for manufacturing a phantom comprising sodium alginate and fat:
2 g of sodium alginate salt are mixed into 48 g of water at room temperature, referred to below as premix 1. For homogeneous mixing, this process takes up to 24 hours, depending on the sodium alginate concentration.
0.2 g of CaCO₃microparticles are mixed into 24.8 g of water. This process only takes a few seconds to obtain a homogeneous dispersion (premix 2). Additional colorants or anti-mold agents can be added in this step if required.
Premix 2 is added to premix 1 and stirred until the dispersion is homogeneous (premix 3). This process takes several minutes, depending on the sodium alginate concentration.
1.25 g of the surfactant decyl glucoside was added to premix 3 and stirred until completely mixed, which is referred to as premix 4.
Add 23.75 g of melted coconut fat to premix 4 and stir vigorously until homogeneous (premix 5).
The premix 5 is degassed in a vacuum chamber to remove air bubbles. This process takes a few minutes.
0.71 g of glucono-delta-lactone (GDL) is added to 24.29 g of water and stirred until it has completely dissolved (premix 6). This process only takes a few seconds.
Immediately after manufacturing premix 6, premix 6 is poured into the degassed premix 5 to obtain the final mixture and stirred carefully so that no air bubbles are formed. The final mixture can be degassed for a short time to remove the last air bubbles. The maximum degassing time available depends on the concentration of sodium alginate, CaCO₃and GDL.
The end product/mixture is poured and molded into the desired shape.

It is possible to swap, combine or carry out the above production steps simultaneously.

The manufacturing of organs, tissues and anatomical landmarks of the phantom according to the invention can be done by molding, 3D printing or other manufacturing methods.

The phantom bodies produced can be used in particular in the training of trainee surgeons and radiologists as well as for practicing a usually difficult procedure, wherein a practice run can lead to a significant improvement in the surgical result.

The multimodal, monomaterial phantom is of particular interest to manufacturers of phantom bodies, companies that produce soft materials or providers of assistance systems for robotic surgery such as Intuitive or Distal Motion.

Real CT images of pathological and healthy objects are preferred for manufacturing a lifelike phantom body. The Hounsfield scale is used to determine the X-ray properties of a material and can be measured and determined at any point on a patient's object. CT images can be used to create a digital file of individual organs or anatomical landmarks. Mechanically, properties can be taken from the literature so that a fully customized phantom can be manufactured from a material system.

Depending on the physiological and anatomical properties and the level of detail required, a phantom can be manufactured in different ways.

The process that enables the most detail is 3D printing with a bioprinter such as Cellink's Bio X, which can combine three different materials.

In another process, the inner channels can be manufactured separately by casting, molding or printing and then integrated into a larger mold, for example to incorporate blood vessels into a harder matrix material.

If an entire phantom body is required, the individual components such as bones, organs, blood vessels etc. are manufactured separately and then incorporated into a larger mold.

The multimodal, monomaterial phantom is characterized by a wide variability in the reproduction of human soft tissue, wherein a largely arbitrary gradability of the measurable radiopacity and elasticity values can be achieved by varying the formulations and controlling the crosslinking process.

This makes it possible to produce even complex anatomical tissue arrangements as phantoms from a single material system, thus reducing manufacturing costs and subsequent disposal costs.

Due to the multimodal quality of the phantom, the field of computer surgery in particular is to be regarded as a target market.

In addition, the conversion of real CT images of a patient into a phantom can lead to patient-specific phantoms in preparation for a difficult procedure, opening up a new market opportunity.

1. A multimodal, monomaterial phantom comprising surrogates for different tissue types, wherein
the phantom is formed from at least two surrogates;
the surrogates are arranged separately, in anatomically corresponding contact with each other;
the surrogates are formed and/or arranged to simulate the same and/or different tissue types;
wherein
the phantom and/or the surrogates consist of exactly one material system at or during manufacturing, wherein the material system comprises a material composition of at least:
sodium alginate
and
glucono-delta-lactone (GDL) or an acid-forming compound by hydrolysis or lactones
and
calcium carbonate
and
fat
and
water
in the form of a hydrogel
and
the material system is formed in at least two different variations of the material system composition within the phantom and/or surrogate.

2. A phantom according to claim 1, wherein by varying formulations and/or percentages within the material composition of the material system and by controlling the polymerization of the hydrogel in the crosslinking process
a diversity and/or adaptability of the formed surrogates is effected or is formed;
within the material system, the CT attenuation and the shear wave velocity can be adjusted independently of one another;
wherein the formed surrogates
can be distinguished from one another with non-invasive medical diagnostic and imaging techniques comprising ultrasound imaging and X-ray CT
mimic the mechanically properties of real tissue as closely as possible;
are cuttable;
are moldable and dimensionally stable.

3. The phantom according to claim 1, wherein the material system comprises dyes and/or anti-mold agents.

4. The phantom according to claim 1, wherein the material system composition comprises variations in the range of (weight-%)
0.1 to 20 percent sodium alginate
0.01 to 20 percent calcium carbonate
0.01 to 20 percent glucono-delta-lactone (GDL)
0.1 to 50 percent fat
0 to 10 percent tenside
0 to 5 percent anti-mould agent
0 to 5 percent colorant
and
water
100% in total.

5. The phantom according to claim 1, wherein the material system is easily disposable or disposable as ordinary organic waste.

6. A method, for
surgical and/or radiological training and/or further training of
specialized personnel,
preparation of surgical interventions,
development and/or calibration of devices for robot-assisted surgery
involving the phantom according to claim 1.

7. A model for modeling
of individual organs and/or tissues,
of organ arrangements and/or tissue arrangements,
of organ arrangements and/or tissue arrangements together with defined pathologies,
of phantom bodies comprising organ arrangements and tissue arrangements
wherein the model is comprised of the phantom according to claim 1.
